(19) United States
(12) Patent Application Publication
(10) Pub. No.: US 2006/0277260 A1
(43) Pub. Date: Dec. 7, 2006

(54) Email system and method for selective transmission of a portion of an email message

(75) Inventor: William C. Hardy JR., Fairport, NY (US)

Correspondence Address: Carter, DeLuca, Farrell & Schmidt, LLP, Suite 225, 445 Broad Hollow Road, Melville, NY, 11747, US

(73) Assignee: Xerox Corporation

(21) Appl. No.: 11/146,641

(22) Filed: Jun. 7, 2005

(51) Int. Cl. G06F 15/16

(52) U.S. Cl. 709/206

(57) ABSTRACT

A system and method are provided for enabling transmission of an email message to one recipient and a portion of the email message to at least another recipient. The system includes an email creation module or email editor module configured to enable one to compose an email message for transmission to at least one remote server. The system further includes a parsing module configured to parse the composed email message into at least two components, where a first component of the at least two components includes the entire email message and at least a second component of the at least two components includes a portion of the email message. The system further includes a transmission module configured to transmit the first component and at least the second component to at least two different email addresses corresponding to at least two different recipients. The at least two different email addresses can belong to two different email aliases or distribution lists.

### BACKGROUND

The present disclosure relates to email editors, and more particularly, to an email system and method for selective transmission of a portion of an email message. More specifically, the present disclosure provides an email system and method for enabling transmission of an email message to one recipient and a portion of the email message to at least another recipient.

Electronic mail systems or editors, such as Microsoft(& Outlook, include a graphical user interface for allowing one to compose and send email messages to individuals identified by corresponding email addresses and groups of individuals identified by an alias or distribution list (name string). An alias or distribution list identifies a group of individuals who are frequently contacted by the sender in order to facilitate identification and/or reduce the burden of repeatedly entering the individual email addresses. As it is well known, a sender can address a single message to many recipients by separating the email addresses of the recipients and/or one or more aliases identifying groups of individuals with a semicolon or comma in a header of the graphical user interface of the email editor.

When the email message is composed in a body of the graphical user interface of the email editor and is transmitted by selecting a “Send” icon, each of the recipients whose email address is provided in the header and all individuals associated with the one or more aliases provided in the header will receive the email message. Conventional email editors do not provide the capability to transmit an email message to one recipient of at least two recipients associated with email addresses provided in the header and transmit a portion of the email message to the other recipient(s) of the at least two recipients. Further, conventional email editors do not provide the capability to transmit an email message to individuals associated with one alias provided in the header and transmit a portion of the email message to individuals associated with one or more other aliases provided in the header.

U.S. Pat. No. 6,775,689 B1 describes a feature in an email editor for sending selected segments of email contents to selected recipients by segmenting the email contents in the body of the email editor into a plurality of segments and identifying in the header of the email editor a recipient list for each segment. To implement this feature, a graphical user interface of a conventional email editor needs to be modified to include new fields in the header for identifying recipient lists for each segment in the body. The graphical user interface of the conventional email editor further needs to be modified to include new fields in the body to associate text/attachments with each segment.

It is an aspect of the present disclosure to provide an email system enabling transmission of an email message to one recipient and a portion of the email message to at least another recipient without requiring modification of a graphical user interface of a conventional email editor.

### SUMMARY

According to the present disclosure, an email system and method are provided for enabling transmission of an email message to one recipient and a portion of the email message to at least another recipient without requiring modification of a graphical user interface of a convention email system or editor, such as, for example, Microsoft® Outlook. The email system and method further enable transmission of an email message to individuals associated with one alias or distribution list and a portion of the email message to individuals associated with one or more other aliases.

The email system according to the present disclosure includes three modules each having a set of programmable instructions configured for execution by at least one processor of the system for performing the functions in accordance with the present disclosure. The first module is an email creation module or email editor module configured to enable one to compose an email message in a body segment displayed by the email creation module for transmission to at least one recipient whose email address is provided in a header segment displayed by the email creation module. The second module is a parsing module configured to parse the composed email message into at least two components, where a first component of the at least two components includes the entire email message and at least a second component of the at least two components includes a portion of the email message.

The email system, based on preset settings, links or associates at least one entered email (or alias) in a header segment to the second component. The email system, also based on preset settings, links or associates at least another entered email (or alias) in the header segment to the first component or the entire email message.

The third module is a transmission module configured to transmit the first component to at least one email address corresponding to a recipient intended to receive the second component. The two different email addresses can belong to two different email aliases, where the first component is transmitted to at least two email addresses belonging to a first email alias and at least the second component is transmitted to at least two email addresses belonging to a second email alias.

In particular, the email system of the present disclosure for selective transmission of a portion of an email message includes at least one processor; an email creation module having a set of programmable instructions configured for execution by the at least one processor for composing the email message; and a parsing module having a set of programmable instructions configured for execution by the at least one processor for parsing the composed email message into at least two components by locating markers within the composed email message. A first of the at least two components includes the email message and a second of the at least two components includes the portion of the email message. The email system further includes a transmission module having a set of programmable instructions configured for execution by the at least one processor for transmitting the at least two components to at least two different email addresses corresponding to at least two different recipients.

The present disclosure also provides a computer system having at least one processor; and an email system for selective transmission of a portion of an email message. The email system includes an email creation module having a set of programmable instructions configured for execution by the at least one processor for composing the email message; and a parsing module having a set of programmable instructions configured for execution by the at least one processor for parsing the composed email message into at least two components by locating markers within the composed email message. A first of the at least two components includes the email message and a second of the at least two components includes the portion of the email message. The email system further includes a transmission module having a set of programmable instructions configured for execution by the at least one processor for transmitting the at least two components to at least two different email addresses corresponding to at least two different recipients.

The method for selective transmission of a portion of an email message in accordance with the present disclosure includes linking at least two different email addresses to at least two components of the email message; and parsing the email message into the at least two components by locating at least one marker within the email message. A first of the at least two components includes the email message and a second of the at least two components includes the portion of the email message. The method also includes transmitting the at least two components to the at least two different email addresses corresponding to at least two different recipients.

The present disclosure also provides a set of programmable instructions configured for being executed by at least one processor for performing a method of selective transmission of a portion of an email message. The method includes linking at least two different email addresses to at least two components of said email message; and parsing the email message into the at least two components by locating at least one marker within the email message. A first of the at least two components includes the email message and a second of the at least two components includes the portion of the email message. The method also includes transmitting the at least two components to the at least two different email addresses corresponding to at least two different recipients.

### BRIEF DESCRIPTION OF THE DRAWINGS

Various embodiments of the present disclosure will be described herein below with reference to the figures wherein:

FIG. 1 is a block diagram of an email system for selective transmission of a portion of an email message in accordance with the present disclosure;

FIG. 2 is a flow chart illustrating a method for selective transmission of a portion of an email message in accordance with the present disclosure; and

FIG. 3 illustrates an email message depicted by a screen view of the email system in accordance with the present disclosure.

### DETAILED DESCRIPTION OF THE PREFERRED EMBODIMENTS

The present disclosure provides an email system and method for enabling transmission of an email message to one recipient and a portion of the email message to at least another recipient without requiring modification of a graphical user interface of a convention email system or editor, such as, for example, Microsoft® Outlook. The email system and method further enable transmission of an email message to individuals associated with one alias or distribution list and a portion of the email message to individuals associated with one or more other aliases.

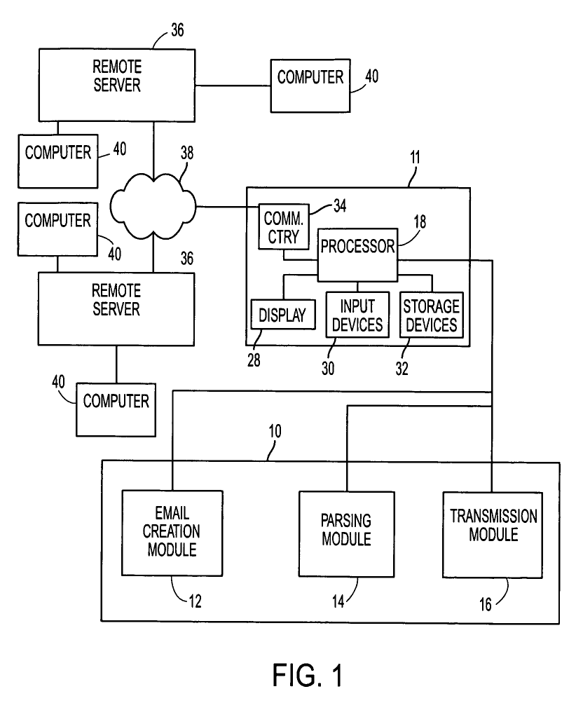

With reference to FIG. 1, there is shown a block diagram of an email system for selective transmission of a portion of an email message in accordance with the present disclosure. The email system is designated generally by reference numeral 10 and includes three modules 12, 14, 16.

Each module includes a set of programmable instructions configured for execution by at least one processor 18 of a computer system 11 for performing the functions in accordance with the present disclosure. The set of programmable instructions can be application software stored within a memory, such as RAM and ROM, of the at least one processor 18 and/or a computer-readable medium, such as a hard drive, CD-ROM, DVD, 3.5″ diskette, etc.

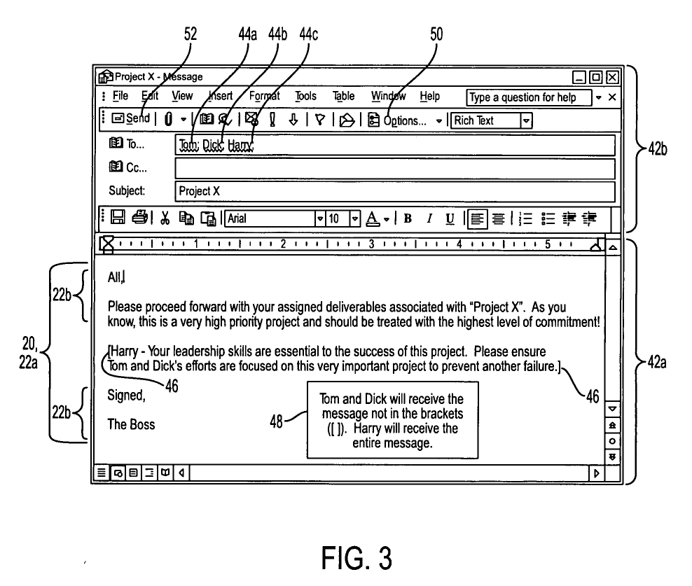

The first module is an email creation module or email editor module 12 configured to enable one to compose an email message 20 (see FIG. 3) for transmission to at least one remote server 36. The second module is a parsing module 14 configured to separate or parse the composed email message 20 into at least two components 22a, 22b (see FIG. 3), where a first component 22a of the at least two components includes the entire email message 20 and at least a second component 22b of the at least two components includes a portion of the email message 20 (e.g., the portion that is not within the brackets in FIG. 3). It is contemplated that the parsing module 14 can be located remotely from the at least one processor 18, such as within a remote server.

The third module is a transmission module 16 configured to transmit the first component 22a and at least the second component 22b to at least two different email addresses 44a, 44b, 44c (see FIG. 3). The at least two different email addresses 44a, 44b, 44c can belong to two different email aliases or distribution lists, where the first component 22a is transmitted to at least two email addresses belonging to a first email alias and at least the second component 22b is transmitted to at least two email addresses belonging to a second email alias.

The three modules 12, 14, 16 can also include additional programmable instructions capable of being executed by the at least one processor 18 for performing other functions which are known in the art for conventional email editors or email systems, such as storing contact information, storing sent and received email messages, searching email messages for particular keywords, adding attachments to composed email messages, etc. The email system 10 can also include additional modules for performing these and other functions.

The at least one processor 18 is in operable communication with a display device 28, one or more input devices 30, such as a keyboard and mouse, one or more external storage devices 32, and communication circuitry 34 for receiving and transmitting messages from and to one or more remote servers 36 via a communications network 38, such as the Internet. The one or more servers 36 are linked to a plurality of computers or terminals 40 as known in the art.

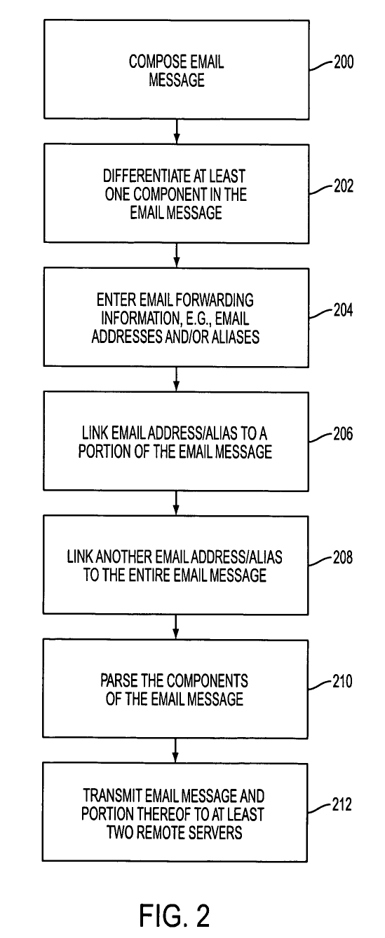

In operation, with reference to FIGS. 2 and 3, the email creation module or email editor module 12 is used to compose the email message 20 in a body segment 42a displayed by the email creation module 12 (Step 200). The email creation module 12 is also used to differentiate the second component 22b in the body segment 42a (Step 202). The second component 22b is differentiated by the use of at least one pair of identifying symbols or markers 46 as shown in FIG. 3. As described herein, the portion of the email message which is not bracketed is identified by the email system 10 as the second component 22b. It is contemplated that the second component 22b can be the portion of the email message within the brackets.

The email creation module 12 is also used to enter email forwarding information, i.e., at least two email addresses; at least two email aliases; or at least one email address and at least one email alias in a header segment 42b displayed by the email creation module 12 (Step 204). In FIG. 3, three email addresses 44a, 44b, 44c are shown as having been entered in the header segment 42b. The email addresses 44a, 44b, 44c are displayed using their corresponding shortcuts: “Tom,” “Dick,” and “Harry.”

The email system 10, based on preset settings, links or associates the first and second entered email addresses 44a, 44b (or aliases) in the header segment 42b to the second component 22b or a portion of the email message 20 (Step 206). The email system 10, also based on preset settings, links or associates the third entered email address (or alias) 44c in the header segment 42b to the first component 22a or the entire email message 20 (Step 208). A window 48 is displayed to the user by the email system 10 informing the user that the first and second entered emails (or aliases) or shortcuts 44a, 44b correspond to the second component 22b and the third entered email (or alias) or shortcut 44c corresponds to the first component 22a or the entire email message 20.

The user can opt to change the preset settings by programming the email system 10 by selecting an “OPTIONS” button 50, such that the entered emails are linked differently. For example, the first and second entered emails (or aliases) 44a, 44b can be linked to the first component 22a or the entire mail message 20 and the third entered email (or alias) 44c can be linked to the second component 22b.

Upon selecting a “SEND” button 52 on the header segment 42b, the set of programmable instructions corresponding to the parsing module 14 are executed by the at least one processor 18. The parsing module 14 scans the composed email message 20 to locate the at least one pair of identifying symbols or markers 46 and hence, separate or parse the second component 22b from the entire email message 20 (Step 210). The second component 22b as stated above is identified as the portion of the composed email message 20 which is not within the brackets.

The at least one processor 18 then executes the set of programmable instructions corresponding to the transmission module 16 for respectively transmitting the first and second components 22a, 22b to a remote server corresponding to the first entered email (or alias) 44a, and at least one remote server corresponding to the second and third entered emails (or aliases) 44b, 44c (Step 212).

In particular, Tom and Dick will receive the following email message: “All, Please proceed forward with your assigned deliverables associated with “Project X”. As you know, this is a very high priority project and should be treated with the highest level of commitment! Signed, The Boss”. Harry will receive the following email message: “All, Please proceed forward with your assigned deliverables associated with “Project X”. As you know, this is a very high priority project and should be treated with the highest level of commitment! [Harry—Your leadership skills are essential to the success of this project. Please ensure Tom and Dick's efforts are focused on this very important project to prevent another failure.] Signed, The Boss”.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A email system for selective transmission of a portion of an email message, said system comprising:
at least one processor;
an email creation module having a set of programmable instructions configured for execution by the at least one processor for composing said email message;
a parsing module having a set of programmable instructions configured for execution by the at least one processor for parsing said composed email message into at least two components by locating markers within said composed email message, wherein a first of said at least two components includes said email message and a second of said at least two components includes said portion of said email message; and
a transmission module having a set of programmable instructions configured for execution by the at least one processor for transmitting said at least two components to at least two different email addresses corresponding to at least two different recipients.

2. The email system according to claim 1, wherein a first of said at least two different email addresses belongs to a first alias and a second of said at least two different email addresses belongs to a second alias.

3. The email system according to claim 1, wherein said email creation modules displays a header segment and a body segment and wherein at least two different email addresses are provided in the header segment and said composed email message is provided in the body segment.

4. The email system according to claim 3, wherein a first of the at least two different email addresses is linked to said first of said at least two components and a second of the at least two different email addresses is linked to said second of said at least two components.

5. The email system according to claim 4, further comprising means for changing linking of said first and second of the at least two different email addresses to said first and second of said at least two components, and vice versa.

6. A computer system comprising at least one processor; and
an email system for selective transmission of a portion of an email message, said email system comprising:
an email creation module having a set of programmable instructions configured for execution by the at least one processor for composing said email message;
a parsing module having a set of programmable instructions configured for execution by the at least one processor for parsing said composed email message into at least two components by locating markers within said composed email message, wherein a first of said at least two components includes said email message and a second of said at least two components includes said portion of said email message; and
a transmission module having a set of programmable instructions configured for execution by the at least one processor for transmitting said at least two components to at least two different email addresses.

7. The computer system according to claim 6, wherein a first of said at least two different email addresses belongs to a first alias and a second of said at least two different email addresses belongs to a second alias.

8. The computer system according to claim 6, wherein said email creation modules displays a header segment and a body segment and wherein at least two different email addresses are provided in the header segment and said composed email message is provided in the body segment.

9. The computer system according to claim 8, wherein a first of the at least two different email addresses is linked to said first of said at least two components and a second of the at least two different email addresses is linked to said second of said at least two components.

10. The computer system according to claim 9, further comprising means for changing linking of said first and second of the at least two different email addresses to said first and second of said at least two components, and vice versa.

11. A method for selective transmission of a portion of an email message, said method comprising:
linking at least two different email addresses to at least two components of said email message;
parsing said email message into the at least two components by locating at least one marker within said email message, wherein a first of said at least two components includes said email message and a second of said at least two components includes said portion of said email message; and
transmitting said at least two components to the at least two different email addresses.

12. The method according to claim 1 1, wherein a first of said at least two different email addresses belongs to a first alias and a second of said at least two different email addresses belongs to a second alias.

13. The method according to claim 11, further comprising providing the at least two different email addresses in a header segment displayed by an email creation module and said email message in a body segment.

14. The method according to claim 13, further comprising changing linking of said at least two different email addresses to said at least two components.

15. A set of programmable instructions configured for being executed by at least one processor for performing a method of selective transmission of a portion of an email message, the method comprising:
linking at least two different email addresses to at least two components of said email message;
parsing said email message into the at least two components by locating at least one marker within said email message, wherein a first of said at least two components includes said email message and a second of said at least two components includes said portion of said email message; and
transmitting said at least two components to the at least two different email addresses.

16. The set of programmable instructions according to claim 15, wherein a first of said at least two different email addresses belongs to a first alias and a second of said at least two different email addresses belongs to a second alias.

17. The set of programmable instructions according to claim 15, further comprising providing the at least two different email addresses in a header segment displayed by an email creation module and said composed email message in a body segment.

18. The set of programmable instructions according to claim 15, further comprising changing the linking of said at least two different email addresses to said at least two components.

19. The set of programmable instructions according to claim 15, wherein the parsing step is performed by executing a set of programmable instructions of a parsing module.

20. The set of programmable instructions according to claim 15, wherein the transmitting step is performed by executing a set of programmable instructions of a transmission module.
